(19) United States
(12) Patent Application Publication
(10) Pub. No.: US 2020/0205446 A1
(43) Pub. Date: Jul. 2, 2020

(54) DEVICE AND METHOD FOR TREATING WITH HIGH-FREQUENCY ACOUSTIC WAVES

(71) Applicants: Gil Ching, LE BAR SUR LOUP (FR); Université D'Avignon Et Des Pays De Vaucluse, AVIGNON Cedex 01 (FR)

(72) Inventors: Gil Ching, LE BAR SUR LOUP (FR); Huguette Sallanon, CHÁTEAUNEUF DE GADAGNE (FR); Florence Charles, CABANNES (FR)

(73) Assignees: Université D'Avignon Et Des Pays De Vaucluse, AVIGNON Cedex 01 (FR); Gil Ching, LE BAR SUR LOUP (FR)

(21) Appl. No.: 16/478,757

(22) PCT Filed: Jan. 16, 2018
(86) PCT No.: PCT/EP2018/050944

§ 371 Date: Jul. 17, 2019

(30) Foreign Application Priority Data
Jan. 17, 2017 (FR) 1770057
Nov. 11, 2017 (FR) 1771277

(51) Int. Cl. A23L 3/30; A23B 7/158; A23L 5/30

(52) U.S. Cl. CPC A23L 3/30; A23L 5/32; A23B 7/158

(57) ABSTRACT

A device for treatment by high frequency sound waves that has at least one enclosure and at least one ultrasound transducer and methods for cleaning foodstuffs in the device. The waves produced by the ultrasound transducer in the enclosure filled with a cleaning liquid have a frequency greater than 100 kHz, preferably greater than 200 kHz.

The invention relates to a device and a method for treating, for example cleaning and/or decontaminating, foodstuffs such as plant food, by high frequency sound waves.

Fruits and vegetables are an essential part of the diet of people around the world, contributing to a supply of essential vitamins and minerals; they can be consumed raw in the first and fourth ranges or processed according to the practices of the agri-food industry in the second, third and fifth ranges.

However, fruits and vegetables grown under conventional farming methods are subject to microbiological contamination and food-borne diseases associated with the consumption of these products are widely present throughout the world and can lead to public health problems. These risks are further increased when agricultural practices minimize inputs, as is the case in organic farming. Indeed, many bacteria, such as Bacillus, Salmonella, Listeria, Staphylococcus, Escherichia, are able to adhere and form a biofilm on different surfaces, for example on the surface of fruits and vegetables (Elhariry, 2011, “Attachment strength and biofilm forming ability of Bacillus cereus on green-leafy vegetables: cabbage and lettuce”, Food Microbiology 28, 1266-1274). Fresh fruits and vegetables are particularly exposed during harvesting, packaging and storage in the cold room during transport, and finally during transformations such as pre-cutting operations, to these various risks of pathogenic contamination.

The control of sanitary quality is one of the key issues, both for the marketing of fresh fruits and vegetables and for raw materials used in the fruit and vegetable processing industries, and in particular the fourth-range industries. Indeed, regardless of the production technique, the preservation process and the final destination of the products, a reduction in the initial microbial load minimizes the risks of contamination throughout the chain of preservation and processing. It is therefore imperative for agri-food industries to ensure sanitary quality upstream of processes and at each stage of processing to ensure the safety of products.

Depending on the nature and origin of the fruits and vegetables, the decontamination operations are essentially aimed at controlling the sanitary quality, i.e. eliminating microorganisms that are pathogenic for humans, but they also participate, in fact, in the elimination of chemical substances (pesticides, fungicides) resulting from phytosanitary treatments. They also aim to control phytopathogenic or opportunistic contamination, non-pathogenic for humans, which develops after the harvest, alters the products in storage and renders them unfit for consumption and marketing. In addition, production conditions that aim to limit the use of phytosanitary products (pesticides, fungicides) before harvest are more prone to the development of microorganisms during storage, which is currently the main cause of losses after the harvest. This issue, which is essential for all types of production, is one of the main factors limiting production in organic farming.

Therefore, in the agri-food sector, washing fruits and vegetables for marketing in fresh form, fourth-range industries and processing industries, is a major step. The main purpose of washing is to minimize microbiological, biological and chemical contaminants on the surface of plants.

In this field, it is known to the person skilled in the art that fruits and vegetables are typically washed with water, the recycling of which is generally not ensured. In certain special cases, such as the transformation in the fourth range, a supply of chlorine is necessary to ensure the sanitary quality (of the order of 80 ppm of chlorine).

Chlorine and chlorinated compounds have been used as disinfectants for decades, and are still to date the only disinfecting substances that have an acceptable cost-efficiency ratio for the agri-food industry. Much work has been done on the effects of chlorine and on sanitary quality (2007, “Comparison of disinfection by product formationfrom chlorine and alternative disinfectants”, Water Research 41, 1667-1678, Al-Zenki et al., 2012, “Microbial safety and sanitation of fruit and fruit products”, In: Handbook of Fruit and Fruit Processing, Wiley-Blackwell, USA, pages 339-340).

Therefore, most methods of washing fresh raw materials use chlorine and large amounts of water, the renewal of chlorinated water being the basis of washing efficiency.

However, chlorine has many disadvantages: in the presence of dissolved organic compounds, by-products such as trihalomethanes, methylene bromides and other molecules considered as toxic in the diet may be formed. A study conducted by the CVUA (Stuttgart) showed that out of 600 plant samples analyzed, 20% contained toxic chlorate residues at concentrations ranging from 0.01 to 0.92 mg/kg. The standard not to be exceeded is currently set at 0.7 mg/kg, currently in force (“Should chlorate residues be of concern in fresh-cut salads?” Gil, Marín, Andujar, Allende Food Control 60 (2016) 416e421).

During the use of chlorine, vapor toxic for operators may also form. In addition, the large-scale use of chlorine in washing baths and its discharge into wastewater also poses an environmental problem. It is for these reasons that the use of chlorine for the purpose of disinfecting raw materials is already prohibited in some countries, particularly in Germany and Switzerland, and this ban is becoming widespread in Europe, among others.

The agri-food industries are therefore increasingly interested in possible alternatives. The search for alternatives to chlorine has been the subject of numerous studies and different approaches that use and combine chemical, biological or physical solutions have been explored. In addition to washing with chlorine or chlorine dioxide, other avenues are studied such as, for example, a combination of several decontamination methods selected from products with acidified sodium chloride, organic acid formulations, alkaline-based disinfectants, hydrogen peroxide, ozonated water, electrolyzed water, peroxyacetic acid, and moderate heat treatments, as well as other physical processes, including ultrasound, ultraviolet radiation, pulsed electric field, oscillating magnetic fields, and high pressure, to reduce the microbial load of fresh fruits and vegetables (Gil et al., 2011, “Treatments to ensure safety of fresh-cut fruits and vegetables” In: Martin-Bellosa, O., Soliva-Fortuny, R. (Eds.), “Advances in Fresh-cut Fruit and Vegetables Processing” (CRC Press, USA, pages 211-223).

More particularly, ultrasound is used for the decontamination of processed products (such as juices, purees, etc.) that do not need to maintain the integrity of living tissues. Indeed, in general, ultrasound with frequencies of 20-100 kHz have the ability to cause cavitation, used in the food industry to inactivate microorganisms (Piyasena et al., 2003, “Inactivation of microbes using ultrasound: a review”, International Journal of Food Microbiology 87 (3), 207-216). Cavitation, necessary for the inactivation of microorganisms, alters the plant cells and does not allow the maintenance of living structures and their preservation in their original condition. Furthermore, it is a non-thermal technology that contributes to increasing antimicrobial safety while preserving nutritional, sensory, functional and heat-sensitive characteristics. A major advantage of ultrasound over other techniques in the food industry is that waves are generally considered safe, non-toxic and environmentally friendly (Kentish and Ashok Kumar, 2011, “The Physical and Chemical Effects of Ultrasound” In: Feng, H., Barbosa-Cánovas, GV, Weiss, J. (Eds.), Ultrasound Technologies for Food and Bioprocessing, Springer, London, pages 1-12).

Recent results, obtained by José Sao, show that ultrasound is effective when limited to frequencies of 45 kHz (“Caracterizaçao fisico-quimica e microbiologica de tomato cerja minimamente processado submetido a diferentes tratementos de sanitizaçao” Thesis Viçosa Minas Gerais Brazil 2013).

Proposals for alternatives to traditional decontamination processes are certainly numerous, but still remain little or not used by companies. The main reason for this is that none of these alternatives are as effective in terms of disinfection or decontamination as chlorine, without altering plant products. Moreover, the alternatives generate significant costs that do not allow use in agribusiness and therefore represent a major obstacle to investment. In addition, other chemical decontaminants are either too oxidizing or too degrading for plants (such as hydrogen peroxide, for example) or insufficiently active against microorganisms (such as combinations of organic acids, for example). Finally, it is often difficult to adapt a production line, and doing it after the fact is even more expensive than to think of a hygienic solution upstream.

Thus, currently, no alternative to the use of chlorine is satisfactory and used by the agri-food industry and chlorine remains the decontaminant used industrially in all cases where the legislation allows.

However, if chlorine ensures a bacteriological and fungal decontamination, it has no particular effect on the chemical residues resulting from the phytosanitary treatments during production. Today however, the presence of chemical residues on fruits and vegetables at harvest, and in particular on lettuces, has been shown in numerous studies on this subject. No current technology proposes to reduce the pesticide load on the surface of vegetables and fruits before processing.

In light of the foregoing, in order to solve the problems listed above and, in particular, to develop an alternative to chlorine cleaning and decontamination, the Applicant has developed a new equipment and a new, environmentally friendly, technology for the optimized cleaning and/or disinfection of products, preferably foodstuffs, while limiting the undesirable effects observed in the prior art.

The implementation of such a technology is advantageously called “green”, that is to say, without addition of chemical contaminants, without release to the environment and without generating by-products harmful to health. This technology advantageously allows a decontamination as effective as that obtained by chlorine. It also allows to eliminate some of the chemical residues. Therefore, it can meet the expectations of professionals throughout the food processing chain and, in particular, the fourth-range processing industries.

Therefore, the first subject matter of the invention is a treatment device using high frequency sound waves, comprising at least one enclosure, which is preferably an overflow tank comprising a liquid, and at least one ultrasound transducer, characterized in that the waves produced by the ultrasound transducer in the enclosure have a frequency greater than 100 kHz, preferably greater than 200 kHz.

The second subject matter of the invention is the use of a device according to the invention, for the treatment of a plant or for the non-therapeutic treatment of an animal placed in the enclosure.

The third subject matter of the invention is the use of a device according to the invention for the ex vivo modification of the metabolism of an organism, an organ or a tissue inserted into the enclosure.

The last subject matter of the invention is a method for cleaning and/or decontaminating by high frequency sound waves, characterized in that it comprises the following steps according to which:

a product to be cleaned and/or decontaminated to break off at least one pollutant particle is placed in an enclosure which is preferably an overflow tank;

sound waves of high frequency, greater than 100 kHz, preferably greater than 200 kHz, are generated in said enclosure by an ultrasound transducer;

the sound waves propagate within the enclosure and reach the product to be cleaned and/or decontaminated; and

the cleaned and/or decontaminated product is recovered.

The invention and the advantages which result therefrom will be better understood on reading the specification and the nonlimiting embodiments which follow, written with reference to the appended figures in which:

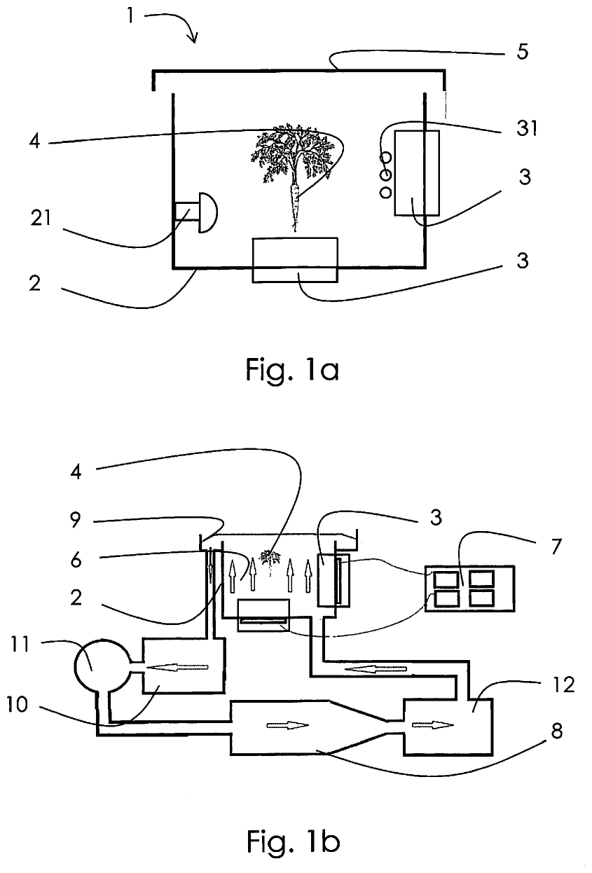

FIGS. 1a, 1b and 1c show schematic diagrams of preferred embodiments of a device for the decontamination of plant foods by high frequency sound waves according to the invention; and

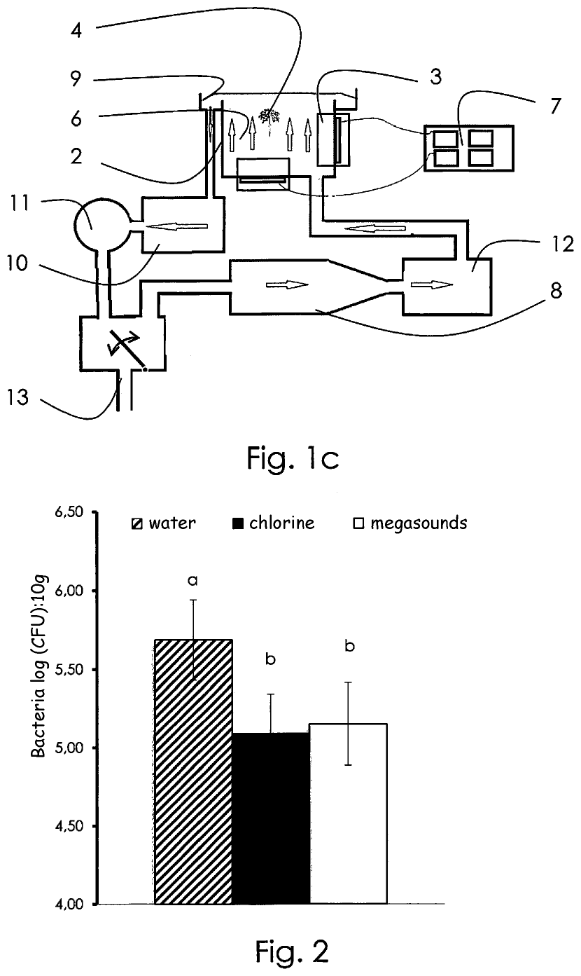

FIG. 2 shows the effect of the use of high frequency ultrasound (megasound) in a device according to the invention on the microbial load of lettuces compared with a treatment with chlorine or with water.

The invention relates to a device for treating products or organisms, preferably foodstuffs, by high frequency sound waves.

According to the invention, treatment is understood to mean the modification of the product or of the organism to be treated, for example cleaning, stimulation, decontamination, sterilization, solubilization or mineralization, with the exception of the therapeutic treatment of an animal, including a human.

Surprisingly, the Applicant has been able to demonstrate that the use of the device, which is the subject matter of the invention, notably makes it possible to clean and decontaminate foodstuffs, preferably plant foods, by high frequency sound waves propagating in a liquid, preferably water, without the addition of a chemical compound. Moreover, one of the characteristics of the device is not to alter the living structures. It will therefore be mainly used with living plant organisms, but can also be used with various matrices whose integrity is to be advantageously preserved.

As illustrated in FIGS. 1a, 1b and 1c, the device 1, which is the subject matter of the invention, essentially comprises at least one enclosure 2 and one ultrasound transducer 3. The enclosure 2 according to the invention is a closed space capable of containing the product(s) 4 to be treated, preferably to be cleaned and/or decontaminated. Preferably, the enclosure is a container intended to receive the products to be treated, preferably to be cleaned and/or decontaminated. As illustrated in FIG. 1, said container may, for example, be reclosable by a lid 5.

The enclosure 2 may be of any geometric shape, for example cylindrical, diamond, oval, ovoid, inverted ovoid, parallelepipedal, frustoconical, inverted frustoconical. It is preferably of cylindrical or parallelepipedal shape.

Also more preferably, the enclosure 2 is a tank having one or more openings for filling, emptying, setting up treatment operations, preferably for cleaning and/or decontamination.

The openings may be valves, possibly provided with a thread allowing, for example, to connect filling or emptying pipes. The diameter of the valves is, for example, about 40 mm, 50 mm or 70 mm.

The openings may also be faucets for taking a sample of the liquid contained in the enclosure, for example for analysis or tasting.

The volume of the enclosure is preferably greater than 0.001 m³, for example between 0.001 m³ and 500 m³. Preferably, the volume of the enclosure is greater than 0.5 m³, for example between 0.5 m³ and 50 m³. More preferably still, the volume of the enclosure is greater than 2.5 m³, for example between 2.5 m³ and 25 m³.

Preferably, the device, which is the subject matter of the invention, may be in the form of a tray adapted for use in the kitchen, whose size is comparable to the lettuce spinners currently on the market, with a capacity of approximately 1 to 5 liters and whose diameter is generally between 20 cm and 45 cm. Furthermore, the device of the invention may incorporate a dewatering module that couples the cleaning and/or decontamination of foodstuffs to their spin before use or packaging.

Depending on the positioning of the ultrasound transducer 3, the enclosure 2, which is preferably a tank, is advantageously made of concrete, fiberglass, stainless steel or coated metal.

In a particularly advantageous manner, as illustrated in FIGS. 1b and 1c, the enclosure 2, which is optionally an overflow tank, comprises a liquid 6.

The liquid 6 allows the diffusion of the sound waves within the enclosure 2.

Preferably, the liquid 6 contained in the enclosure is a treatment liquid, preferentially for cleaning, comprising for example: water; electrolyzed water; calcium oxide or quicklime, which is generally used mixed with water in the proportion of 10%; hypochlorites and, in particular, sodium hypochlorite or bleach, which is generally used mixed with water; chlorine dioxide; sodium chlorite; sodium chlorate; potassium chlorate; alcohol, which is generally either ethanol or isopropanol; organic acids such as calcium lactate; peroxyacetic acid; hydrogen peroxide or oxygenated water; iodine; ozone; phenol and phenolic compounds; potassium permanganate; quaternary ammonium salts; toluene; and/or vinegar or acetic acid; said above mentioned components being used alone or in admixture for the preparation of the treatment liquid, preferably for cleaning.

Preferably, the liquid 6 contained in the enclosure is used in solution, very diluted.

Preferably, the treatment or cleaning liquid 6 is water, fresh or saline. More preferably, the treatment or cleaning liquid 6 is fresh water. By way of nonlimiting example of usable fresh water, mention may be made of drinking water such as mineral water, spring water or reverse osmosis water.

Preferably, the water used in the device 1 according to the invention is a drinking water.

Alternatively, in order to further increase the treating, cleaning and/or decontaminating power of the device according to the invention, the water of the treatment liquid, preferably of the cleaning liquid, may contain one or more other cleaning and/or decontamination agent(s) selected from detergents and/or disinfectants.

Detergents are agents whose mode of action is physical or physicochemical.

Non-limiting examples of detergents that may be used include: alkalis such as, in particular, sodium hydroxide, potassium hydroxide, carbonate and trisodium phosphate; acids such as, in particular, phosphoric, nitric and acetic acids; and chelating agents such as sodium pyrophosphate and EDTA (ethylene diamine tetraacetic acid).

Non-limiting examples of disinfectants that may be used include: halogens, in particular chlorine and its derivatives, which are particularly easy to use and inexpensive, especially bleach (sodium hypochlorite) and sodium chlorocyanurates, or even iodine derivatives; oxides and peroxides such as hydrogen peroxide, ozone and peracetic acid; aldehydes such as formaldehyde and glutaraldehyde; surfactants and in particular quaternary ammoniums; acids often used for descaling; bases more often associated with chlorine in the form of chlorinated alkalis; alcohols; and physical agents such as ionizing radiation and UV rays.

The device 1 according to the invention further comprises at least one ultrasound transducer 3, that is to say, a device converting electrical energy into acoustic energy in the ultrasonic range.

Advantageously, the transducer 3 according to the invention is composed of a single ceramic made from a homogeneous or piezo-composite material. Transducers 3 are resonant elements, such as tuning forks.

According to the invention, the ultrasound transducer 3 of the device 1 produces waves of a frequency greater than 100 kHz, preferably greater than 200 kHz in the enclosure 2. More preferably still, the wave frequency is greater than 500 kHz. Particularly advantageously, the frequency of the waves produced in the enclosure is between 1 MHz and 5 MHz. Such high frequency ultrasounds higher than 1 MHz are also called megasounds.

According to a particular embodiment of the invention, the frequency of the waves is between 1.6 MHz and 2.3 MHz.

According to a particular embodiment of the invention, the frequency of the waves is 1 MHz, 1.5 MHz, 1.6 MHz, 1.7 MHz, 1.8 MHz, 1.9 MHz, 2.0 MHz, 2.1 MHz, 2.2 MHz, 2.3 MHz, 2.5 MHz or 3 MHz.

The frequency of the ultrasounds or ultrasonic waves generated by the ultrasound transducer 3 is fundamental. Indeed, the principle of the treatment, cleaning and/or decontamination using the device 1 according to the invention is based on the mechanical effects of the acoustic wave. The first effect of the presence of sound waves, for example in the vicinity of the epidermis of a plant, is to promote the dissolution of soluble products deposited on the plant. Indeed, the particle velocity of the acoustic wave renews the liquid in contact with the soiled part.

The solid parts attached to the plant, generally small, are excited by the waves that propagate within the treatment or cleaning liquid. The dimension of the particles is compared to the dimensions that characterize the acoustic wave in the tank 2. The characteristic quantities are the wavelength (distance between two pressure maxima) and the acoustic boundary layer, also called the viscous boundary layer (distance between the plant surface and the area where the particle velocity is no longer subject to adherence conditions). These two quantities are linked to the frequency of the wave. The higher the frequency, the smaller these quantities are.

For megasonic waves, that is to say, whose frequency is greater than 1 MHz, the wavelength is of the order of 0.5 mm to 2 mm in the water, and the acoustic boundary layer is about 1 micron in the water if the frequency is 1 MHz.

It has been shown that if the particle placed on the product 4 to be treated, cleaned and/or decontaminated, which is, for example, a plant, is larger than the boundary layer, the particle has part of its surface (the part farther from the support) subjected to the acoustic velocity field, but it is also subjected to the acoustic pressure field (alternating pressure/vacuum). The forces resulting from this environment make the particle vibrate and break off easily.

In general, the particles deposited on the product 4 to be treated, cleaned and/or decontaminated are associated with trapped air microbubbles. The acoustic wave makes this bubble vibrate and makes it change volume which contributes to destabilize the particle and make it break off.

In the case of cleaning and/or decontamination of a plant 4, the megasounds can penetrate the crevices of the epidermis of plants to dislodge any type of soil thanks to their very short wavelength. The stronger the acoustic power, the better the cleaning efficiency. On the other hand, if the acoustic power is too strong and exceeds a certain threshold, the phenomenon of cavitation can appear.

“Cavitation threshold” means the acoustic power required to cause cavitation, that is to say the creation and implosion of a gas bubble.

For “strong cavitation”, the bubble contains the gaseous phase of the liquid which supports the acoustic wave. The bubble subjected to variations in acoustic pressure oscillates and then implodes. At the time of the implosion, very intense pressures are generated, as well as high temperature rises. Light emissions can then be seen.

This “strong cavitation” should be compared to the “weak cavitation” for which the bubble consists of dissolved gases present in the cleaning liquid 6. The pressures and temperatures due to this phenomenon are safe for plants. In this case, there is no light radiation. The use of very high frequency ultrasound, preferably megasounds, makes it possible to have a very wide range of acoustic power without reaching the strong cavitation. The device according to the invention allows to control the presence of strong cavitation, thanks to the acoustic signature characteristic of strong cavitation.

Advantageously, the Applicant has thus been able to demonstrate that treatment, cleaning and/or decontamination by megasonic waves are thus particularly well suited to fragile substrates such as plant foodstuffs, and more particularly fruits and vegetables. The device 1 envisaged uses ultrasonic waves of very high frequency, preferably megasounds, without ever reaching the strong cavitation.

The ultrasound transducer 3 according to the invention is preferably composed of at least one piezoelectric ceramic. Also more preferably, the ultrasound transducer 3 is composed of a set of piezoelectric ceramics.

The family of piezoelectric ceramics includes many elements, such as, in particular, barium titanates (BaTiO3) or lead Zircono Titanates (PZT or LZT for Lead Zirconate Titanate), which are the most widespread and which alone account for five to six different compositions. Preferably, the ceramics used are PZT (lead zirconate titanate) ceramics such as PZT-4, PZT-5 or PZT-8 ceramics. More preferably, the ceramics used are ceramics intended for acoustic emission having a quality factor greater than 500 such as PZT-5.

The ultrasound transducer 3, which is preferably composed of a set of piezoelectric ceramics, may be arranged on the outer and/or inner walls of the enclosure 2.

Piezoelectric ceramics can be present on any type of wall, both horizontal walls and vertical walls.

Advantageously, the waves are well distributed in the enclosure 2 thanks to the fact that the ceramics 3 are placed homogeneously on the walls of the tank. All the walls of the enclosure 2, which is preferably a tank, can be equipped. Preferably, the piezoelectric ceramics 3 are present on one, two, three, four or five walls of the enclosure 2.

To obtain a homogeneous acoustic field, ceramics of small sizes, that is to say less than 10 cm and preferably between 2 cm and 4 cm are used. This allows optimal paving. Their shape is usually circular or polygonal.

Each ceramic is powered by an independent generator calibrated on the resonant frequency of the ceramic.

Preferably, each ceramic has its own resonant frequency. Two ceramics of the same batch do not have the same resonant frequency.

The fact that the natural frequencies of the ceramics are different prevents stationary waves from settling in the tank. This has the advantage of improving the acoustic homogeneity in the tank.

The ultrasound transducer 3, which is preferably a set of ceramics, preferably comprises an adjustment module 7.

Thus, to further optimize the homogeneity, when each ceramic is powered by its own electronics, a random phase shift is created by said adjustment module 7. Advantageously, the ceramics are previously desynchronized, thus avoiding the occurrence of stationary waves and allowing to have a diffuse field.

Alternatively, to homogenize the sound field and avoid standing wave phenomena, it is possible to vary, thanks to the adjustment module 7, the excitation frequency in the vicinity of the natural frequency of each ceramic, the range of excursion depending on the quality of the ceramic.

Preferably, the adjustment module 7 of the transducer 3, which is preferably made of piezoelectric ceramics, is an electronic power card. Thus, each piezoelectric ceramic is preferably powered by an electronic power card providing an AC voltage corresponding to its own mode of vibration.

In addition, to avoid areas where the acoustic power would be too strong, it is possible to advantageously place obstacles to diffract the sound waves. The shape and material of the diffractor are adapted to the desired acoustic directivity.

To optimize the operation of the device, the acoustic power must be maximum, but it is imperative that there be no cavitation in the treatment tank. Thus, as illustrated in FIG. 1a, an hydrophone 21 immersed in the tank advantageously makes it possible to constantly monitor the presence of cavitation. Indeed, the implosion of cavitating bubbles generates a characteristic frequency spectrum. Thus, as soon as cavitation is detected, the acoustic power is reduced until the cavitation phenomenon is no longer detected by the hydrophone 21.

The device, which is the subject matter of the invention, advantageously comprises an immersed hydrophone 21.

As is apparent from FIG. 1a, the circles 31 of the ultrasound transducer 3 represent an acoustic diffraction device.

According to a particular embodiment of the invention, it is possible to increase the sites in which the weak cavitation occurs, by the introduction of dissolved gas or microparticles into the liquid contained in the enclosure.

Thus, the device according to the invention preferably comprises a gasification system of the treatment or cleaning liquid, not shown in the figures, advantageously comprising a semipermeable membrane.

The gas is preferably introduced through a semipermeable membrane separating the gas to be dissolved and the treatment or cleaning liquid. The nature of the gas is adapted to the product to be treated, cleaned and/or decontaminated. For example, a mixture of nitrogen, oxygen and carbon dioxide, taken alone or as a mixture, in which the selected concentrations make it possible to limit breathing.

The gas dissolved in the treatment or cleaning liquid may, for example, be treated in a sonochemical reactor and, depending on its nature, may contribute to the destruction of microorganisms.

The Applicant has been able to demonstrate that a combination of high frequency sound waves, preferably greater than 100 kHz, or even 200 kHz, coupled with a dissolved gas supply, makes it possible to obtain several distinct and complementary advantages:
high-frequency sound waves, preferably greater than 100 kHz, make it possible, in particular, to eliminate micro-organisms (bacteria, viruses, fungi), organic molecules (various deposits, pesticides) present on the surface and in the microcracks of the products, while limiting the damage to the products to be treated, cleaned and/or decontaminated, even the most fragile, for example, in the epidermis, including the natural pores (stomata and lenticels, for example) of plants to be cleaned and/or decontaminated. This effect applies to all situations where microbiological or chemical decontamination is necessary or may be useful. It can also be used to break off unwanted products originating from plants (for example, oxidation products) during various agri-food processes, for example.
the sound waves, by creating convection movements, promote the circulation of the treatment or cleaning liquid, preferably water. They therefore have a homogenizing effect on the aqueous media in contact with the products to be treated, cleaned and/or decontaminated. Thus, the device can also be used to avoid the creation of concentration gradient (for example, in the substrates used in hydroponic plant culture, or in washing water during agri-food processes). It can also be used in all cases where improved wettability improves the process (for example, germination of seeds, absorption of water or any other substance).
the number of surface sites in which the weak cavitation occurs is increased thanks to the introduction of dissolved gases into the treatment or cleaning liquid. The gas is introduced through a semipermeable membrane separating the gas to be dissolved and the treatment or cleaning liquid. The nature of the gas is adapted to the matrix to be treated. The gas dissolved in the treatment or cleaning liquid is generally neutral and has an effect on the number of cavitation sites. It may also, depending on its nature, contribute to the efficiency of the treatment.

By way of nonlimiting example of contaminating particle(s) to be destroyed present on the products to be treated, cleaned and/or decontaminated, mention may be made, for example, of microorganisms, bacteria, fungi, viruses, pesticides, fungicides, or solid particles.

The Applicant has been able to highlight in particular that, in spore form, fungi are very resistant to many decontamination processes (chemical decontaminants, UV radiation). Surprisingly, the device, which is the subject matter of the invention, makes it possible to eliminate both the sporulated forms and the non-sporulated forms of the fungi from the surface.

Therefore, the device 1 according to the invention also allows to break off the pollutant particles, which are in suspension or in solution in the treatment or cleaning liquid 6, if the particles are soluble.

Generally, the soiled cleaning liquid 6 flows in the tank from bottom to top and overflows the tank.

Advantageously, the device, which is the subject matter of the invention, comprises a flow circuit of the treatment or cleaning liquid.

Said circuit comprises at least one additional module selected from a sonochemical reactor 8, a weir 9, a filter 10 and/or a circulation pump 11.

According to a first embodiment of the invention, the device according to the invention and/or the flow circuit of the treatment or cleaning liquid of said device comprises a sonochemical reactor 8.

The sonochemical reactor 8 allows in particular the mineralization of all the organic substances present in the aqueous medium. Therefore, it advantageously destroys both organic molecules (such as pesticides, fungicides, etc.) and microorganisms (viruses, fungi in spore form or not, bacteria). It is preferably used in addition to the sound waves in all cases where the substances resulting from acoustic treatment, must be eliminated. It is thus particularly useful, for example, for the recycling of process water.

The Applicant has been able to demonstrate that when the device according to the invention further comprises a sonochemical reactor, it makes it possible to have multiple applications in various sectors of agronomy and agri-food.

For example, the device is particularly suitable for the treatment of fruit and vegetables destined for the fresh market and agri-food processing, but it is also suitable for hydroponic crops. In the case of plants, for example, the device allows the elimination of microorganisms and surface chemicals and contributes to the sanitary quality of products destined for fresh storage and agri-food processing. In the case of plants grown by hydroponic culture, the device allows the homogenization of nutrient solutions (acoustic megasounds) and the reduction of the formation of biofilms on the culture supports. The mineralization (sonochemistry) of organic matter and microorganisms of nutrient solutions is provided by the sonochemical reactor, which has an effect on the sanitary quality of the crops and allows the recycling of water. The device also has effects on the physiology of plants: by eliminating concentration microgradients very close to the root, it facilitates the absorption of water and/or nutrient solutions and thus improves the growth of the plants.

The sonochemical reactor 8 according to the invention is essentially intended to produce the active substances necessary for the destruction of microorganisms and/or pesticides. This reactor 8 is preferably located in the flow circuit or in a circulation loop of the cleaning device. The sonochemical reactor 8 is an enclosure comprising a liquid inlet and an outlet. In this reactor, ultrasonic waves “cavitate” dirty water (strong cavitation). Indeed, it has been shown that acoustic cavitation results in the creation of microbubbles of dissolved gas, the oscillation of these bubbles leading to their implosion. This implosion is reflected, in the vicinity of the bubble, by overpressures (of the order of 500 atm), solar temperatures (2000° C. to 5000° C.) and UV light radiation.

The sonochemical reactor 8 also allows the creation of free radicals OH⁻ according to the reaction:

H₂O+ultrasounds→OH⁻+H⁺
pyrolysis in cavitation bubbles
oxidation by radicals OH⁻
full mineralization of pesticides→CO₂ residues

Thus, all these steps allow the sonochemical reactor 8 to destroy pesticides. Indeed, these free radicals OH⁻ have many chemical properties. In particular, they allow to destroy microorganisms. The number of cavitation sites fixes the amount of free radicals created, thus the capacity of the reactor to destroy a given level of pollutants.

Thus, all these steps allow the sonochemical reactor 8 to destroy microorganisms and pesticides following a full mineralization. Unlike many processes that eliminate pesticides by transforming them into other molecules whose nature or dangerousness is unknown, the present device destroys them without the appearance of newly formed molecules. The number of cavitation sites fixes the amount of free radicals created, thus the capacity of the reactor to destroy a given level of pollutants.

Strong cavitation is obtained for high levels of sound intensity and is obtained for all frequencies, but, preferably, the frequencies are between 40 kHz and 400 KHz.

By way of non-limiting example of sonochemical reactors 8 that can be used according to the invention, mention may be made of Langevin-type transducers such as the model STC 8HS 3528 manufactured by Sunnytec Piezoelectric Technology. This model consists of two piezoelectric discs, 5 mm thick, with a 35 mm outer diameter and a 5 mm inner diameter, mechanically connected in series and electrically connected in parallel. These discs are compressed between two metal masses. On one side, they are in contact with an aluminum metal cone, 35 mm in diameter, on the ceramic side, 55 mm in diameter on the other side and 40 mm in length. On the other side, they are bounded by a stainless steel cylinder, 35 mm in diameter and 18 mm long. The entire structure is held by an M10 screw that passes through the component.

According to a second embodiment of the invention, the flow circuit of the treatment or cleaning liquid of said device further comprises one or more filters 10, 12, which are advantageously:
a porous filter 10 for the filtration of large particles and/or
a porous microparticle filter 12.

The porous microparticle filter 12 of the device according to the invention comprising a sonochemical reactor 8 advantageously makes it possible to obtain a recirculation water which is potable and suitable for treating, cleaning and/or decontaminating foodstuffs after passing through said reactor 8. Indeed, the solid particles are stopped by the filter(s) 10, 12, whereas the organic substances are preferably destroyed by the sonochemical reactor 8.

Preferably, the filter(s) 10, 12 used according to the invention are selected from carbon filters.

According to a preferred embodiment of the invention, the filter 10, 12 is not a cold-plasma activated carbon filter such as the O2PRO™ module developed by Cartis™.

The flow circuit of the treatment or cleaning liquid of the device may also contain an evacuation system which is advantageously a weir 9 and/or a circulation pump 11.

Thus, according to a third embodiment of the invention, the device according to the invention and/or the flow circuit of the treatment or cleaning liquid of said device further comprises a weir 9. The weir 9 is a structure allowing to divert or discharge the treatment or cleaning liquid 6 behind a winnowing or fixed dam, the height of which would exceed a certain limit.

According to a fourth embodiment of the invention, the device according to the invention and/or the flow circuit of the treatment or cleaning liquid of said device further comprises a circulation pump 11. Said circulation pump 11 is mainly intended to force the circulation of the treatment or cleaning fluid.

According to a fifth embodiment of the invention, the flow circuit of the treatment or cleaning liquid of the device that is the subject of the invention comprises two modules selected from a sonochemical reactor 8, a filter 10, 12, a weir 9, and a circulation pump 11.

Preferably, according to this fifth embodiment, the invention relates to a coupled device of high frequency sound waves, sonochemistry and dissolved gas supply which advantageously applies to post-harvest treatments of fruits, vegetables (leaves, roots, tubers, bulbs) and seeds (cereals, legumes and others); to hydroponic crops, nurseries or in vitro culture. The device may be used at all stages of plant development (seed germination, explant development, vegetative growth and fruit formation and development). In the agri-food industry, the device can also be applied to meat products, fish and may have applications in the dairy industry.

According to a sixth embodiment of the invention, the flow circuit of the treatment or cleaning liquid of the device that is the subject of the invention comprises three modules selected from a sonochemical reactor 8, a filter 10, 12, a weir 9, and a circulation pump 10.

According to a seventh embodiment of the invention, the flow circuit of the treatment or cleaning liquid of the device, which is the subject matter of the invention, comprises the following four modules:
a weir 9,
a porous filter 10,
a recirculation pump 11,
a sonochemical reactor 8, and optionally
a microparticle filter 12.

According to an eighth embodiment of the invention, the device according to the invention and/or the flow circuit of the treatment or cleaning liquid of said device comprise all of the following elements:
a gasification system of the treatment or cleaning liquid 6,
a weir 9,
a porous filter 10,
a recirculation pump 11,
a sonochemical reactor 8, and optionally
a microparticle filter 12.

The device that is the subject of the invention also has the advantage of reducing the consumption of treatment or cleaning liquid or of water that is necessary for treating, cleaning and/or decontaminating the products. It is particularly interesting for the washing of certain vegetables such as lettuces with a device comprising a closed flow circuit.

According to a particular embodiment, several tanks 2 may be used with larger or smaller volumes.

As indicated above, the device according to the invention allows the treatment of products or organisms, preferably foodstuffs, by high frequency sound waves.

The invention thus also relates to the use of a device according to the invention, for the treatment of a plant or for the treatment, non-therapeutic, of an animal, placed in the enclosure.

According to the invention, treatment is understood to mean the modification of the product, the foodstuff or the organism to be treated, for example cleaning, stimulation, decontamination, sterilization, solubilization or mineralization, with the exception of the therapeutic treatment of an animal. The device of the invention has applications also in baby food for which the regulation prohibits the use of pesticides (heavy metals, nitrates, etc.) or decontamination products (quaternary ammonium, chlorate . . . ). The device according to the invention is associated with additional modules, not shown in the figures, allowing, for example, the control of raw materials, the washing, the peeling, the removal of unwanted pieces by a refiner, the preparation of the recipe, the packaging, the encapsulation for example by steam jet, the sterilization or pasteurization, the control, and/or the coding for traceability.

The device that is the subject of the invention also has applications in the value chain for marketing meat such as poultry. The device, which is the subject matter of the invention, is then optionally associated with additional modules, not shown in the figures, allowing, for example, hooking, anesthesia or bleeding of animals, opening of the pores to facilitate plucking (scald tank), defeathering, evisceration and/or cutting of certain limbs, internal and external washing, and/or conditioning.

The device, which is the subject matter of the invention, has applications also in hydroponic crops, in particular for actively combating the appearance of biofilms.

Thus, the invention also relates to the use of the device for the treatment of foodstuffs inserted into the enclosure, preferably plant foodstuffs.

More particularly, the device according to the invention is used for cleaning and/or decontaminating foodstuffs placed in the enclosure (2), preferably plant foodstuffs.

More particularly still, the plants to be decontaminated are preferably selected from fruits, vegetables, seeds, tubers or any part of an edible plant.

The vast majority of plants must be washed before marketing in fresh form or packaging for agri-food processing. A special case for which the decontamination requirements are more important is that of the industries that manufacture fourth-range products. Fourth-range products are ready-to-use fresh fruits and vegetables. They are washed, cut and stored in bags, usually under a modified atmosphere for about seven days. The cutting operations bring the internal substrates of the plants into contact with the microorganisms, which facilitates their development. Therefore, the decontamination requirements of these products are very important and the plants undergo several washes, one before and one after the cutting operations. Although lettuces are the most transformed plant product in the fourth range, manufacturers are diversifying their offer to vegetable mixes and want to develop a fourth-range fruit offering, limited for the moment by a too short shelf life.

The device, which is the subject matter of the invention, is also particularly suitable for plants that are sensitive desiccation during transport, are intended for the fourth range, the tubers and fruits to be peeled.

Plants cleaned and/or decontaminated with the device according to the invention advantageously have a longer shelf life and improved quality.

According to an alternative embodiment of the invention, the device can be used for the treatment of foodstuffs of animal origin placed in the enclosure. Thus, the device is particularly suitable for brining foodstuffs, preferably brining foodstuffs of animal origin, more preferably still ham.

The purpose of this treatment is to modify the diffusion of product through the liquid/food interface. When the fluid in the vicinity of the interface is immobile, the diffusion is called molecular, the flow of molecules crossing the interface depends on the difference in product concentration on either side of the interface. The flux (number of molecules passing through the area measuring unit per unit of time) is proportional to the local concentration gradient. Over time, when the liquid is at rest, the concentration of active product decreases as it approaches the interface; the same is true in the product to be treated. This results in a decrease of this gradient in both the liquid and the foodstuff. By exciting the interface with an acoustic wave, the fluid is constantly renewed, the migration of active molecules being then increased since, in this case, the concentration of active product is fixed at its initial value and is invariable over time. The overall result is to reduce the treatment time to reach the desired dosage.

Surprisingly, the Applicant has been able to demonstrate that the use of brine in the tank or the enclosure 2, followed by a treatment of foodstuffs by the device according to the invention, notably makes it possible to reduce the brining time.

The Applicant has also been able to demonstrate that the device that is the subject of the invention makes it possible to modify the metabolism of an organism, an organ or a tissue, the modification preferably taking place ex vivo when the organism, the organ or the tissue is placed in the enclosure 2.

An organism according to the invention is a complex and organized system, which is the product of successive variations during its evolution. It consists of one or more cells (of a unicellular or multicellular organism).

According to the invention, an organ is a set of specific tissues of an organism capable of performing one or more specific functions.

According to the invention, a living tissue is the intermediate level of organization between the cell and the organ. A tissue forms a functional whole, that is to say that its cells contribute to the same function.

Preferably, the organism, organ or tissue is of animal or plant origin.

More particularly, the Applicant has in particular been able to show that the device allowed to create tearing forces in the boundary layer of certain plants.

Thus, it was possible to show that these tearing forces could, in particular, allow to: promote contact between the surface of the tissues, especially of the living ones, and the liquid 6 or solvent; and create a mechanical stimulation on the surface.

This can have multiple consequences. The reduction of the boundary layer makes it possible, for example, to increase the interactions between: the surface of the cells of an organism, an organ or a tissue 4, on the one hand; and the chemical compounds of the liquid 6 contained in the enclosure 2 with which they are in contact, on the other hand.

As a result, the absorption of various molecules or their rejects will be amplified.

The adsorption of molecules or macromolecules on the cell surface will also be modified by the device according to the invention.

The device according to the invention can therefore be used to modify the exchanges between the organisms, the organs or the tissues 4 and the treatment liquid 6.

It appears that the creation of a mechanical stimulation on the surface of the cells is perceived by a living organism, preferably a plant, as a stress which modifies the permeability (direct action on the membrane channels, on the lipids, on the electrical transmembrane potential, on the conformation of proteins, etc.). This mechanical stimulation triggers a cascade of cellular reactions, up to a neosynthesis of primary and secondary metabolites.

Advantageously, the device, that is the subject of the invention, thus makes it possible to modify the metabolism of an organism, an organ or a tissue, said modification preferably taking place ex vivo when the organism, the organ or the tissue is placed in the enclosure 2, and allowing, for example, the neosynthesis of primary and/or secondary metabolites.

The device according to the invention can thus advantageously be used to modify the metabolism of organisms, organs or tissues either by stimulating or by repressing the synthesis of cellular compounds.

Advantageously, the device according to the invention can be used to modify the metabolism of an organism, an organ or a tissue by stimulating its growth. Preferably, the organism is a plant organism, the organ is a plant organ and the tissue is a plant tissue.

The device according to the invention can also be used to increase the defenses of a plant organism, a plant organ or a plant tissue against infection with a pathogen which is preferably a fungus.

Two examples of use of the device according to the invention to modify the metabolism of organisms, organs or tissues are illustrated in Examples 3 and 5.

As is apparent from these examples, the Applicant has been able to demonstrate that root treatment by the device according to the invention stimulates the growth of plants and increases the defenses of the leaves against infection by a pathogenic fungus. These two examples show that the effects of the treatment are not limited to the organ treated, but induce an overall systemic response of the plant and a change in metabolism.

The invention finally relates to a method for cleaning and/or decontaminating by high frequency sound waves, characterized in that it comprises the following steps according to which:
a product 4 to be cleaned and/or decontaminated from at least one pollutant particle is placed in an enclosure 2 which is preferably an overflow tank;
high frequency sound waves, greater than 100 kHz, preferably greater than 200 kHz, are generated in said enclosure 2 by an ultrasound transducer 3;
the sound waves propagate within the enclosure 2 and reach the product to be cleaned and/or decontaminated 4; and
the cleaned and/or decontaminated product is recovered.

Thus, the last subject matter of the invention is a method for cleaning and/or decontaminating a product by using the device according to the invention described above.

Advantageously, the method is characterized in that the enclosure 2 comprises a cleaning liquid 6 and in that said method comprises an additional treatment step by a flow circuit of the cleaning liquid, soiled and loaded with pollutant particles, according to which:
the cleaning liquid, soiled and loaded with pollutant particles, is passed through a filter 10;
the liquid thus filtered enters into a recirculation pump 11 and then into a sonochemical reactor 8, with a frequency of between 40 kHz and 400 kHz, in which the pollutant particles are destroyed; and
the liquid free of pollutant particles is either replaced in the enclosure 2, or placed in a secondary circuit 13.

The above steps may be freely interchanged by the person skilled in the art. For example, the cleaning liquid, soiled and loaded with pollutant particles, may be placed in a secondary circuit at the first step above, that is to say, before the optional step of passage through a filter 10.

Furthermore, the method may further comprise an additional step of filtering the cleaning liquid through a microparticle filter 12. Thus, when the cleaning liquid initially contained in the enclosure (overflow tank) is potable water, it is possible to completely decontaminate the soiled water recovered in the flow circuit to recycle it into potable water, ready to be optionally reinjected into the enclosure 2 of the device.

Finally, the method that is the subject matter of the invention, preferably comprises a step of desynchronization of the piezoelectric ceramics of the ultrasonic transducers 3 which makes it possible to avoid the formation of standing waves and obtain a diffuse field.

The present invention will now be illustrated by means of the following examples:

### Example 1: Effects of Megasound Treatment on the Cleaning and Decontamination of Lettuces

For this example, the plant decontamination tests were carried out on a typical leafy vegetable, the lettuce, for a fourth-range preservation.

The methodology for determining the microbiological contamination of lettuces is described below:

The lettuce leaves are removed and placed in a sterile STOMACHER™ bag, under sterile air in a laminar flow hood, in a tryptone-salt solution (18 g·L⁻¹) containing 0.2% Tween 80 (2-[2-[3,4-bis(2-hydroxyethoxy)oxolan-2-yl]-2-(2-hydroxyethoxy)ethoxy]ethyl octadec-9-enoate). The tryptone-salt solution (mixture of tryptone and sodium chloride) is isotonic and ensures the revivification of microorganisms that have undergone sublethal treatments.

The tryptone-salt (or peptone-salt) medium is a low peptone isotonic diluent used for dilutions in food or cosmetic analyzes.

Ingredients in grams for one liter of distilled or demineralized water:
Tryptone (casein peptone) 1.00
Sodium chloride (salt) 8.50
final pH at 25° C.: about 7.0

The ratio of amount of vegetable matter to tryptone-salt solution was optimized to 10 g of matter per 90 ml of solution. The sample is then ground in a STOMACHER™-type mill with alternating blade movements, which allows homogenization of the samples directly in sterile bags. A sample of the grinding solution is then seeded into a petri dish in order to count the microorganisms. Three different nutrient media are used:
30 g·L⁻¹ PDA (Potato Dextrose Agar-agar) medium: this medium is preferably adapted to mushroom cultivation and is composed of potato extract, glucose and bacteriological agar-agar.
23.5 g·L⁻¹ PCA (Plate Count Agar-agar) medium: this medium is preferably adapted to bacteria culture and contains yeast extract, enzymatic digest of casein, glucose and bacteriological agar-agar.
glucose chloramphenicol agar-agar medium composed of 5 g of yeast extract, 20 g of glucose, 0.1 g of chloramphenicol, 15 g of agar-agar per liter of solution; this medium does not allow bacterial growth.

All media are autoclaved at 121° C. for 15 min.

The grinding solution is then diluted from 10⁻¹ to 10⁻⁴. Seeding is carried out in petri dishes containing PDA and PCA media at the rate of 100 μl of the grinding solution or the diluted solution, per dish. Each seeding is repeated three times. The dishes are isolated from the outside by PARAFILM™ and are incubated at 25° C. for 72 hours.

Counting is done using the following formula:

N=Σcolonies/Vml×(n1+0.1n2)×d1

where
N: number of CFU per gram or per ml of initial product
Σ colonies: total of countable colonies
Vml: volume of solution deposited (0.1 ml)
n1: number of dishes considered at the first dilution retained
n2: number of dishes considered at the second dilution retained
d1: factor of the first dilution with which developed colonies can be counted.

The results are presented as mean with standard deviation and the analysis of variance (ANOVA) is used as a statistical test.

For this example 1, a cleaning and/or decontamination device as shown in FIG. 1b is used. High frequency sound waves are applied during the washing and used in order to make the pollutant particles break off, such particles being, for example, microorganisms located mainly on the surface of plant foodstuffs, which are, in this case, lettuces, of the baby lettuce variety.

The ceramics of the device used have a resonant frequency of about 1.6 MHz. The diameter of ceramics is 20 mm. The individual power is about 30 W per ceramic.

Between five and twenty ceramics are placed on the bottom of the tank, covering an overall surface of between 15 and 40 cm2 and an average power between 150 W and 400 W.

According to the conventional method used in the fourth range (positive control of this example), the lettuces, baby lettuce variety, are trimmed, cut and then soaked for 3 minutes in a chlorine solution (80 ppm). They are then rinsed for 5 minutes, wrung out and stored in bags at 6° C. for 7 days. The permeability of the bags used makes it possible to obtain an internal atmosphere comparable to that of the air, in order to prevent the possibility that an atmosphere enriched in CO₂ slow the development of microorganisms.

In order to determine the effects of very high frequency ultrasounds, preferably megasounds, different treatment and rinsing times were tested.

The tests (not included in this example) have shown that the preferred duration of treatment is between 0.5 and 5 minutes.

For this example, the results were obtained with a megasound treatment time of 3.6 or 12 minutes, a rinse time of 5 minutes, a rinse rate of 0.5 L/min and a lettuce load of 65 g/L. Microbiological analyzes were performed before bagging and after 3 and 7 days of storage.

It has also been shown that the efficiency of the rinsing depends on the configuration of the water flow and can very easily be optimized.

FIG. 2 compares bacterial contamination of lettuces after washing with water, with chlorine and after treatment with megasounds in water for three minutes. The letters a and b indicate that the results are significantly different—Mann and Whitney test threshold of significance 5%.

As can be seen from the results in FIG. 2, it appears that decontamination with megasound treatment is as effective as chlorine treatment.

After three and seven days of storage, it appears that the contamination increases for all treatments (chlorine, water and megasounds).

However, it appears that megasound treated lettuces maintain a lower bacterial load than those washed with water. Megasound treated lettuces maintain a bacterial load comparable to that in the presence of chlorine.

In addition, the quality of the fourth-range lettuce is not modified by the treatment with megasounds which is true throughout the storage time.

Thus, megasounds are an alternative to using chlorine for fourth-range transformation processes. The use of the device according to the invention not only allows effective decontamination comparable to chlorine, but it avoids the problems associated with the use of chlorine which can cause the appearance of toxic chlorate residues or by-products such as trihalomethanes, methylene bromides and other molecules considered toxic in food. Moreover, the use of the device according to the invention makes it possible to maintain the initial quality of the products.

### Example 2: Effects of Megasound Treatment on the Decontamination of Apples and Strawberries

For this example, the plant decontamination tests were carried out on two types of fruit, whose shape of the epidermis is very different, namely, the apple and the strawberry.

As for the lettuce leaves of Example 1, the epidermis of apples or whole strawberries are removed and placed in a sterile STOMACHER™ bag. The methodology for determining the microbiological contamination of fruits is identical to that described in Example 1 above.

For this example 2, a cleaning and/or decontamination device as shown in FIG. 1b is also used. High frequency sound waves are applied during washing and used in particular to break off pollutant particles such as microorganisms located mainly on the surface of foodstuffs, which are in this case apples and strawberries.

The ceramics of the device used have a resonant frequency varying between 1.5 MHz and 2.5 MHz. The diameter of ceramics is 20 mm. The individual power is about 30 W per ceramic.

Between seven and twelve ceramics are placed on the bottom of the tank, covering an overall surface of between 20 and 35 cm2 and an average power between 200 W and 350 W.

Apples and strawberries were treated substantially under the same conditions as those described in Example 1.

The negative control of this example is the unwashed fruit. It is compared with washing with water and treatment with the device according to the invention as illustrated in FIG. 1.

Chlorine is not used in this example because it does not enter the processes of washing fruit for consumption or preservation in fresh form.

The results of the study are shown in Table 1 below, which compares the microbial load (log (CFU)/10 g) of apples and strawberries before washing, after washing with water for three minutes and after treatment by the megasound system for three minutes. The letters a and b indicate that the results are significantly different—Mann and Whitney test threshold of significance 5%

TABLE 1
Microbial load of apples and strawberries before washing and after
washing with water and after a treatment according to the invention

| Microbial load | | | Treatment |
|---|---|---|---|
| (bacteria | Negative | Positive control | according to |
| and fungi) | control | (washed with water) | the invention |
| log CFU/10 g | (unwashed) | (after 3 min) | (after 3 min) |
| Apple | 4.45 ± 0.1 (a) | 4.1 ± 0.15 (b) | 2.8 ± 0.08 (c) |
| Strawberry | 4.45 ± 0.05 (a) | 4.1 ± 0.04 (b) | 3.1 ± 0.06 (c) |

Considering the results detailed in Table 1 above, it appears that the use of megasounds allows more efficient decontamination of foodstuffs than the simple washing with water.

The device according to the invention makes it possible, in particular, to improve the decontamination of fruits by one log CFU and can be applied to all fruits and vegetables.

### Example 3: Effect of Megasound Treatment on the Growth of Lettuce Plants

The Applicant has shown that the device according to the invention could also be used to homogenize the hydroponic culture media, limit the accumulation of exudates in the vicinity of the roots and thus promote the absorption of water and mineral salts. Homogenization also makes it possible to limit the appearance of biofilms. The invention can be used provided that it does not have negative effects on the growth of the plants.

Example 3 was therefore carried out to determine the effects of megasounds on plant growth.

A batch of 30 young lettuce seedlings at the cotyledonary stage were treated with megasounds for five minutes. The height of the plants and the number of leaves 10 and 20 days after the treatment are shown in Table 2 below. The letters a and b indicate that the results are significantly different—Mann and Whitney test threshold of significance 5%.

TABLE 2
Height and number of seedling leaves of lettuce treated according
to the invention for five minutes at the cotyledonary stage

| | Culture time | | | |
|---|---|---|---|---|
| | 10 days after treatment | | 20 days after treatment | |
| | | Treatment | | Treatment |
| | Untreated | according to | Untreated | according to |
| | control | the invention | control | the invention |
| Plant height (cm) | 7.5 ± | 9.2 ± | 16.3 ± | 19.5 ± |
| | 0.5 (a) | 0.4 (b) | 0.3 (c) | 0.8 (d) |
| Number of leaves | 3 ± | 4 ± | 6 ± | 7 ± |
| | 0.05 (a) | 0.05 (b) | 0.08 (c) | 0.05 (d) |

As is apparent from Table 2 above, it appears that, surprisingly, the treatment with the device according to the invention stimulates the growth of plants and their tolerance against various biotic and abiotic stresses. This effect is maintained until twenty days after treatment.

### Example 4: Method for Decontaminating Plant Foodstuffs with High Frequency Sound Waves According to the Invention

For this example, the decontamination method uses the device that is the subject matter of the invention, as illustrated in FIG. 1b.

The cleaning phase is provided by megasonic waves (frequencies greater than or equal to 1 MHz) coupled with a dissolved gas supply.

Finally, the decontamination phase is performed by traditional acoustic frequency of the order of 40 kHz to 400 kHz.

The method comprises the following steps wherein:
a. plant foodstuffs 4, possibly contaminated with at least one pollutant particle, are immersed in an overflow tank comprising a cleaning liquid 6 and sources of megasonic sound waves 3 with a frequency greater than or equal to 1 MHz;
b. megasounds propagate within the liquid contained in the tank 2 and reach the plant foodstuffs 4 to be decontaminated;
c. the permanent renewal of the liquid in contact with the plant promotes the dissolution of the soluble products deposited on the plants;
d. the propagation of megasounds creates spatial and temporal alternations of compression and depression which are able to mechanically bias the plant foodstuffs to decontaminate and break off the pollutant particle(s) from the foodstuff;
e. the mechanical effect according to d) is amplified by low cavitation when the pollutant particle(s) is/are associated with an air bubble trapped when the plant foodstuffs were immersed in the tank in that the acoustic wave vibrates and changes the volume of said air bubble and destabilizes the pollutant particle(s) which is/are broken off; the dissolved gas promotes the appearance of cavitation sites;
f. the cleaning liquid 6, soiled and loaded with pollutant particle(s), can be treated;
g. the depollution of the liquid is obtained in the sonochemical reactor 8;
h. in this reactor, the sound waves with a frequency between 40 kHz and 400 kHz and very high power make it possible to achieve strong cavitation;
i. in sites where cavitation is taking place, ultraviolet light radiation, overpressures (about 500 bar) and temperature rises (about 4000° C.) have direct or indirect actions for pollutants;
j. direct actions: pressure, temperature, UV can destroy micro-organisms;
k. indirect actions through the creation of free radicals OH, highly oxidizing radicals being able to react with many components.

The implementation of the method detailed above is carried out thanks to three complementary devices that are:
the cleaning tank 2 with megasonic sound waves;
the gasification system of the cleaning liquid;
a sonochemical reactor 8 with cavitation;
   and thanks to two secondary devices that are:
a porous filter 10, 12; and
a recirculation pump 11.

The tank 2 is an overflow cleaning tank containing the plants to be cleaned 4, the plants being completely immersed in the cleaning liquid.

The cleaning liquid arrives from the bottom of the tank 2. Thus, a flow is established from the bottom to the top of the tank.

The liquid fills the tank, then overflows over the high edges of the tank in a weir 9.

This upward flow allows the liquid to carry out loose particles. The circulation of the liquid is ensured by a pump 11.

At the outlet of the tank, the cleaning liquid is loaded particles broken off from the food to be cleaned and/or decontaminated and contains solubilized elements.

The soiled liquid 6 is then filtered by the porous filter 10.

The circulation of the liquid 6 is ensured by the pump 11.

The liquid 6, freed of particles, enters the sonochemical reactor 8 where acoustic cavitation destroys microorganisms and pesticides.

The liquid 6 may advantageously enter a gasification device equipped with a semi-permeable membrane, the gas dosage being managed by the pressure exerted on the gas.

The liquid 6 returns to the cleaning tank 2 freed from all pollutants and possibly gasified.

The recirculation flow rate is adapted to the acoustic performance of the cleaning tank 2 and the performance of the reactor 8.

The preferred cleaning liquid 6 is water to which it may be possible to add soluble products or wherein gases may be to dissolved.

The ceramics generating the sound waves in the tank 2 can be glued to the inner or outer walls of the tank. Alternatively, a removable and immersible device is also conceivable.

Each piezoelectric ceramic is powered by a power electronic card 7, providing it with an alternating voltage corresponding to its own mode of vibration.

Thanks to all these arrangements of the cleaning tank 2, the acoustic field generated that propagates in the cleaning liquid 6 is homogeneous, the plants immersed in the liquid 6 are uniformly insonnified, so that the flipping of the plant foodstuffs to be decontaminated is less significant.

The cleaning efficiency is such that the treatment is carried out under standard conditions at 20° C. and atmospheric pressure. The duration of the cleaning cycle is short, which allows to consider an in-line treatment.

### Example 5: Effect of Megasound Treatment on the Tolerance of Lettuce Leaves to Infection with Botrytis cinerea

Batches of 30 young lettuce seedlings at the cotyledonary stage and five-leaf stage, were treated with the device for five minutes.

Two days after the treatment, the open leaves are removed and placed in a petri dish on damp paper. A calibrated agar cube, which carries mycelium from the pathogenic fungus, is placed on the leaf blade next to the main rib. The dishes are then transferred to a culture chamber at 25° C. and infection monitoring is measured by determining the surface of the necrosis of the leaf blade, by image analysis, after 2, 3 and 4 days.

TABLE 3
Surface of necrosis due to Botrytis cinerea infection of lettuce
leaves isolated after 2, 3 and 4 days of infection.
Necrosis surface (cm²)

| | | |
|---|---|---|
| Days after | | Treatment according |
| infection | Untreated control | to the invention |

Cotyledonary stage

| | | |
|---|---|---|
| Day 2 | 0.45 ± 0.09 (a) | 0.16 ± 0.04 (b) |
| Day 3 | 2.35 ± 0.35 (c) | 1.01 ± 0.2 (d) |
| Day 4 | 1.97 ± 0.2 (e) | 1.2 ± 0.2 (f) |

Five-leaf stage

| | | |
|---|---|---|
| Day 2 | 1.03 ± 0.13 (a) | 0.37 ± 0.08 (b) |
| Day 3 | 2.4 ± 0.2 (c) | 1.17 ± 0.23 (d) |
| Day 4 | 7.9 ± 0.7 (e) | 4.2 ± 0.6 (f) |

Treatment with the device was performed at the cotyledonary stage and at the five-leaf stage two days prior to contact with the fungus.

As evidenced by Table 3 above, it appears that the treatment with the device that is the subject matter of the invention limits the necrosis of the plants infected by the pathogenic fungus Botrytis cinerea.

1. A device for treatment by high frequency sound waves, comprising:
an enclosure comprising a liquid, and at least one ultrasound transducer,
wherein the waves produced by the ultrasound transducer in the enclosure have a frequency greater than 100 kHz.

2. The device according to claim 1, wherein the treatment is cleaning and/or decontaminating foodstuffs.

3. The device according to claim 1, wherein the waves produced by the ultrasound transducer in the enclosure have a frequency greater than 500 kHz.

4. The device according to claim 1, wherein the ultrasound transducer is a set of piezoelectric ceramics disposed on the outer and/or inner walls of the enclosure.

5. The device according to claim 1, further comprising an adjustment module for the piezoelectric ceramics.

6. The device according to claim 1, further comprising a gasification system of the cleaning liquid comprising a semipermeable membrane.

7. The device according to claim 1, further comprising a cleaning liquid flow circuit comprising at least one additional module selected from a sonochemical reactor, a filter, a weir, or a circulation pump.

8. The device according to claim 7, wherein the cleaning liquid flow circuit comprises:
a weir,
a porous filter,
a recirculation pump, and
a sonochemical reactor.

9. The device according to claim 1, further comprising an immersed hydrophone.

10. The device according to claim 1, wherein the enclosure is an overflow tank comprising a liquid.

11-16. (canceled)

17. A method for cleaning and/or decontaminating by high frequency sound waves, the method comprising:
providing an enclosure comprising a liquid and at least one ultrasound transducer, wherein the waves produced by the ultrasound transducer in the enclosure have a frequency greater than 100 kHz;
placing a product to be cleaned and/or decontaminated from at least one pollutant particle in the enclosure;
generating high-frequency sound waves, greater than 100 kHz in said in the enclosure by the ultrasound transducer;
wherein the high-frequency sound waves propagate within the enclosure and reach the product to be cleaned and/or decontaminated; and
recovering a cleaned and/or decontaminated product from the enclosure.

18. The method according to claim 17, wherein the enclosure comprises a cleaning liquid and said method further comprises treating by a flow circuit of the cleaning liquid, soiled and loaded with pollutant particles:
passing the cleaning liquid, soiled and loaded with pollutant particles, through a filter;
passing the liquid thus filtered to a recirculation pump and then a sonochemical reactor, with a frequency in the 40-400 kHz range, thereby destroying the pollutant particles; and
reintroducing the liquid free of pollutant particles in to the enclosure, or placing the liquid fee of pollutant particle in to a secondary circuit.

19. The method according to claim 17, wherein the product is a plant or animal.

20. The method according to claim 19, wherein the product is a plant foodstuff or an animal foodstuff.

21. The method according to claim 17, wherein the product is an organism, organ or tissue, and the method provides ex-vivo modification of the metabolism of the organism, organ or tissue.

22. The method according to claim 21, wherein the organism, organ, or tissue is from a plant, and the modification stimulated the growth of the plant organism, plant organ, or plant tissue.

23. The method according to claim 21, wherein the organism, organ, or tissue is from a plant and the modification increased the defense of the plant organism, plant organ, or plant tissue against infection by a pathogen.

24. The device according to claim 17, wherein the enclosure is an overflow tank comprising a liquid.

25. The device according to claim 1, wherein the frequency is greater than 200 kHz.

26. The device according to claim 3, wherein the frequency is between 1 MHz and 5 MHz.

27. The device according to claim 5, wherein the adjustment module is an electronic power card.

28. The device according to claim 8, wherein the cleaning liquid flow circuit has a microparticle filter.
